(19) United States
(12) Patent Application Publication
(10) Pub. No.: US 2018/0342364 A1
(43) Pub. Date: Nov. 29, 2018

(54) CONTROL METHOD FOR BI-STABLE CONTACTORS WITH FULL COMPONENT REDUNDANCY

(71) Applicant: Lithionics LLC, Safety Harbor, FL (US)

(72) Inventors: Dimitri Butvinik, Woodland, CA (US); Christopher Gary Hakimian, Oldsmar, FL (US)

(73) Assignee: Lithionics LLC, Safety Harbor, FL (US)

(21) Appl. No.: 15/990,580

(22) Filed: May 25, 2018

Related U.S. Application Data
(60) Provisional application No. 62/512,125, filed on May 29, 2017.

(51) Int. Cl. H01H 47/22; H02J 7/00

(52) U.S. Cl. CPC H01H 47/226; H02J 7/345; H02J 7/0013

(57) ABSTRACT

The invention comprises a method and a circuit design to control a bi-stable contactor in such a way that contactor coils can be energized in the event of sudden and unexpected loss of battery power. The invention also includes a component redundancy scheme designed to survive any single component failure SHORT or OPEN as required by industry safety standards UL1973 and UL991.

### CROSS-REFERENCE TO RELATED APPLICATIONS

This application claims priority to an earlier-filed provisional application No. 62512125, EFS ID #29333302

### STATEMENT REGARDING FEDERALLY SPONSORED RESEARCH OR DEVELOPMENT

None

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC (SEE § 1.52(E)(5)). THE TOTAL NUMBER OF COMPACT DISCS INCLUDING DUPLICATES AND THE FILES ON EACH COMPACT DISC SHALL BE SPECIFIED

Not Applicable

### STATEMENT REGARDING PRIOR DISCLOSURES BY THE INVENTOR OR A JOINT INVENTOR

Not currently aware of relevant prior disclosures.

### BACKGROUND OF THE INVENTION

### Field of the Invention

The general field of the invention is batteries and other forms of energy storage. The subject invention comprises a method and a circuit design to control a bi-stable contactor in such a way that contactor coils can be energized in the event of sudden and unexpected loss of battery power. The invention also includes a component redundancy scheme designed to survive any single component failure SHORT or OPEN.

### Background

Large electric batteries are used in energy storage systems in variety of applications such as grid stabilization, solar energy harvesting, off-grid house power, recreational vehicles and boats, etc. Such systems require management and safely controls to prevent unwanted release of energy, which could result in fire, explosion, property damage, bodily injury, etc. This control system is called Battery Management System (BMS). BMS is essentially an intelligent switch, designed to open battery circuit and prevent further charge or discharge of the battery in case unsafe conditions are detected by the BMS sensors.

Electro-mechanical contactors are still the most cost effective and reliable safety switching devices in large, high power battery systems compared with more expensive solid-state switches like FETs and IGBTs. However, classic Normally Open contactor has a major drawback, its coil consumption can be as high as 2 W, which contributes to idle loss of energy up to 1.5 k Wh per month. This can become a major design hurdle in some offline battery applications.

Bi-stable contactors have separate coils for SET (ON) and RESIST (OFF) and don't consume any energy in a stable ON or OFF state. To change the state brief pulse of electric current is applied to one of the coils. This resolves the idle load challenge, but presents a new challenge, how to open the contactor in a case of sudden loss of battery power, and how to design this control scheme with enough redundancy to qualify for UL1973/UL991 certification.

### BRIEF SUMMARY OF THE INVENTION

The subject invention comprises a method and a circuit design to control a bi-stable contactor in such a way that contactor coils can be energized in the event of sudden and unexpected loss of battery power. The invention also includes a component redundancy scheme designed to survive any single component failure SHORT or OPEN as required by industry safety standards UL1973 and UL991

### BRIEF DESCRIPTION OF THE DRAWING

FIG. 1 is a functional electrical diagram, depicting all key components required for operation of the invention and how those components interact.

### DETAILED DESCRIPTION OF THE INVENTION

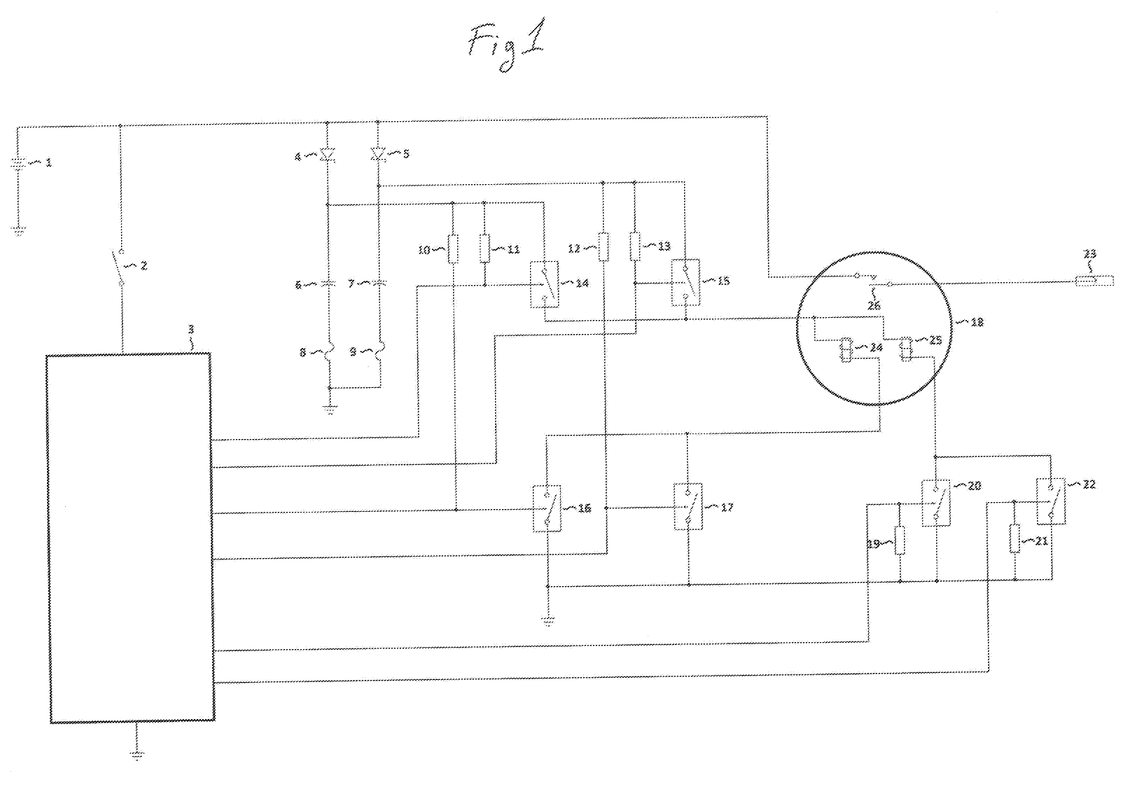

With reference to FIG. 1 of the drawing, there is illustrated a schematic circuit diagram of the invention. The current flows from the battery 1 to the load 23. Large electrolytic capacitors 6 and 7 are used to store electric energy to energize contactor coils 24 and 25. Each capacitor is charged from the battery 1 thru a Schottky diode 4 and 5 to prevent bleeding off the energy from the capacitor back into the battery with minimal voltage losses due to diode's forward voltage drop. Contactor coils 24 and 25 are operated by brief pulses of energy to change the state of the bi-stable contractor 18, to turn the power relay on or off 26. Electronic switch circuits are employed to energize those coils by software commands from the microcontroller 3 (MCU) which is powered by battery through a switch 2 connected to a driver pin on the MCU 3. To provide required redundancy both high side and low side switches are used, and each switch has a parallel redundant switch. High side and low side switches provide FAIL-SHORT redundancy, allowing control of the circuit if any single switch fails short. Parallel switches provide FAIL-OPEN redundancy, allowing control of the circuit if any single switch fails open. Each switch is controlled by dedicated MCU pin, allowing control of the circuit if any single MCU pin fails short or open, or fails short to ground or short to supply voltage. To protect from component failure in the capacitor circuit, two capacitor circuits are used, each with their own diodes. Each capacitor circuit also has series connected PTC fuse, 8 and 9, protecting the circuit from capacitor failing short. Each capacitor circuit powers one set of parallel switches, thus providing redundant power path for the coil. Switches used for RESET coil are designed to be normally active, depicted here by use of pull-up resistors. In this way when MCU fails or power is lost unexpectedly, all 4 switches for RESET coil will activate and engage the RESET coil, resulting in open battery circuit, which is desired safety outcome for BMS operation.

FIG. 1 is functional electric diagram of the invention. However, the invention can be housed in a separate container or incorporated as a part of a larger construct. It is operated by the flow of energy from the battery 1 and control signals from the MCU 3.

Electrolytic capacitors 6 and 7 are charged from the battery 1 through a pair of Schottky diodes 4 and 5 to prevent backflow of current in case of sudden loss of battery power. PTC fuses 8 and 9 protect from possible shorts circuits inside the capacitors. 6 and 7 are large electrolytic capacitors, each storing enough energy to change contactor 18 state at least two times in absence of battery power.

14, 15, 16, 17, 20, and 22 are high side and low side integrated FET power switches, which can be driven directly by CMOS signals from the MCU pins.

10, 12, 13, 14 are pull-ups. Their respective switches are normally active. These switches are closed when driver pin is disconnected or MCU power is lost. MCU control is required to keep the switches open during normal operation. In this scheme, the RESET coil 24 would immediately activate from energy stored in capacitors 6 and 7 in case battery power is lost unexpectedly.

19 and 21 are pull-downs. Their respective switches are normally inactive. These switches are open when driver pin is disconnected or MCU power is lost. This ensures SET coil 25 would not engage without MCU control.

All of the switches are connected to pins on the MCU. To switch the contactor to the on position MCU pins for switches 14, 15, 20, and 22 are briefly activated by the MCU software to energize SET coil. To switch the contactor into the off position MCU pins 14, 15, 16, and 17 are bristly activated by the MCU software to energize RESET coil 24.

This control scheme has redundant components in every circuit and can survive any single component failing SHORT or OPEN.

### “SEQUENCE LISTING,” IF ON PAPER (SEE §§ 1.821 THROUGH 1.825)

Not Applicable

What is claimed is:

1. A battery management system circuit in which the flow of current from the battery to the load is determined by the state of a bi-stable contractor. The circuit comprising:
a. A battery powering an MCU and providing power to the load. The flow of current being controlled with bi-stable contractor comprising of switch, a Set (Closed) and Reset (Open) coil. Each of the coils connected to the MCU through a high side and low side integrated FET power switches which can be driven directly by signals from the MCU.
b. A set of two, parallel, capacitors, each charged through a Schottky diode. Each capacitor storing enough energy to change the bi-stable contractor state at least two times in the absence of power and preceding the upside contactor switches in the circuit. Each capacitor having a PCT fuse.
c. Each capacitor circuit powers 2 sets of parallel switches operating the Reset coil these switches are normally active. Each have a parallel pull up resistor.
d. Two parallel switches for the Set Coil set to open when power is lost. Each of these switches has a parallel pull down resistor.
